(19) United States
(12) Patent Application Publication
(10) Pub. No.: US 2022/0164817 A1
(43) Pub. Date: May 26, 2022

(54) Systems and Methods for Updating Mandated Rules, Deadlines, and Procedures in a Community Exchange System

(71) Applicants: Jeffrey Dracup, Encinitas, CA (US); Alexander Dracup, Encinitas, CA (US); Terry Bell, Encinitas, CA (US)

(72) Inventors: Jeffrey Dracup, Encinitas, CA (US); Alexander Dracup, Encinitas, CA (US); Terry Bell, Encinitas, CA (US)

(21) Appl. No.: 17/100,817

(22) Filed: Nov. 21, 2020

(51) Int. Cl. G06Q 30/02; G06Q 50/18; G06F 16/958

(52) U.S. Cl. CPC G06Q 30/0208; G06Q 30/0233; G06F 16/958; G06Q 50/18; G06Q 30/0232

(57) ABSTRACT

In an embodiment, a system and methods for updating rules, deadlines, and procedures in a community exchange system are provided. Users of the system, which may be contributors who update and introduce new triggering events and their associated rule and best practices deadlines and/or subscribers who use the system to calculate deadlines using the most up-to-date rule and best practice deadlines provided by the system, communicate with a server using their personal devices through a network or network(s). Contributors may receive rewards which may be converted into credit for use of the system to calculate deadlines or used for other purposes.

### TECHNICAL FIELD

The present disclosure is directed to a community exchange system in which users provide updated mandated rules, deadlines and/or procedures, and in particular to a system that provides a level of confidence in the changes.

### BACKGROUND

Governments and professional associations establish rules, procedures, deadlines, and “best practices” that need to be conformed to by professions and industries. Practitioners are not normally notified of these changes individually, so they must rely on constantly reading government publications which indicate these changes or rely on a service to perform that task for them.

For example, in the legal profession there are thousands of court deadline rules listed in the United States. Some services exist that provide court rule and deadline updating, but they all rely on a crew of employees to perpetually check whether the rules have changed and then to manually update those rules, creating overhead and relatively expensive subscription fees. Traditional court rule services also see an exponential growth in rule-entry staffing requirements as they add more jurisdictions and add rules at more granular levels such as in law, where deadline rules can be slightly different as we progress from the state to the the county, city, courthouse and even judicial officer levels. Each jurisdiction and jurisdictional subregion adds rule entry and updating requirements.

This problem exists in other professions and industries as well, for example, accounting, medicine, construction, and telecommunication.

### BRIEF DESCRIPTION OF THE DRAWINGS

The accompanying drawings, which are incorporated herein and constitute part of this specification, illustrate exemplary aspects of the claims, and together with the general description given above and the detailed description given below, serve to explain the features of the claims.

FIG. 1 is a diagram showing a system for updating mandated rules, deadlines, and procedures in a community exchange system according to an embodiment

FIG. 2 shows a flowchart describing an operation for a contributor to enter a rule according to an embodiment.

FIG. 3 shows a flowchart showing a rule submission operation from the server side according to an embodiment.

FIG. 4 shows a flowchart showing a date calculation operation at the server.

FIG. 5 shows a flowchart for a general operation for updating mandating rules, deadlines, and procedures in a community exchange system.

FIG. 6 is a block diagram illustrating an example wireless communication device suitable for use with the various aspects described herein.

FIG. 7 is a block diagram illustrating an example computing device suitable for use with the various aspects described herein.

FIG. 8 is a block diagram illustrating an example server suitable for use with the various aspects described herein.

### SUMMARY

In an embodiment, a system and methods for updating mandated rules, deadlines, and procedures in a community exchange system are provided. Users of the system, which may be contributors who update and introduce new rule deadlines and/or subscribers who use the system to calculate deadlines using the most up to date rule deadlines provided by the system, communicate with a server using their own personal devices through a network or network(s).

When a contributor finds a new or updated rule or is notified by the system of a new or updated rule, the contributor can review and submit the new rule deadline data to the server or indicate that no change is necessary. The server may perform an initial confidence filter using any of various analysis techniques to get a first determination of confidence that the new rule deadline data is accurate. The new rule deadline data is posted for other users to review and provide feedback, such as confirmation, corrections, or questions. This information is used to verify the new rule deadline data, and if it is verified, the new rule deadline data is stored and used to calculate deadlines in response to users of the system's request and the confidence score of that contributor is increased. If it it marked as incorrect by other contributors or users, the confidence score of that contributor will be decreased.

Rewards may be provided to the original contributor and other users who participated in the verification process based on the value and accuracy of their respective contributions. The rewards may be converted into credit for use of the system to calculate deadlines or for account credit or payment to the contributor and verifiers.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

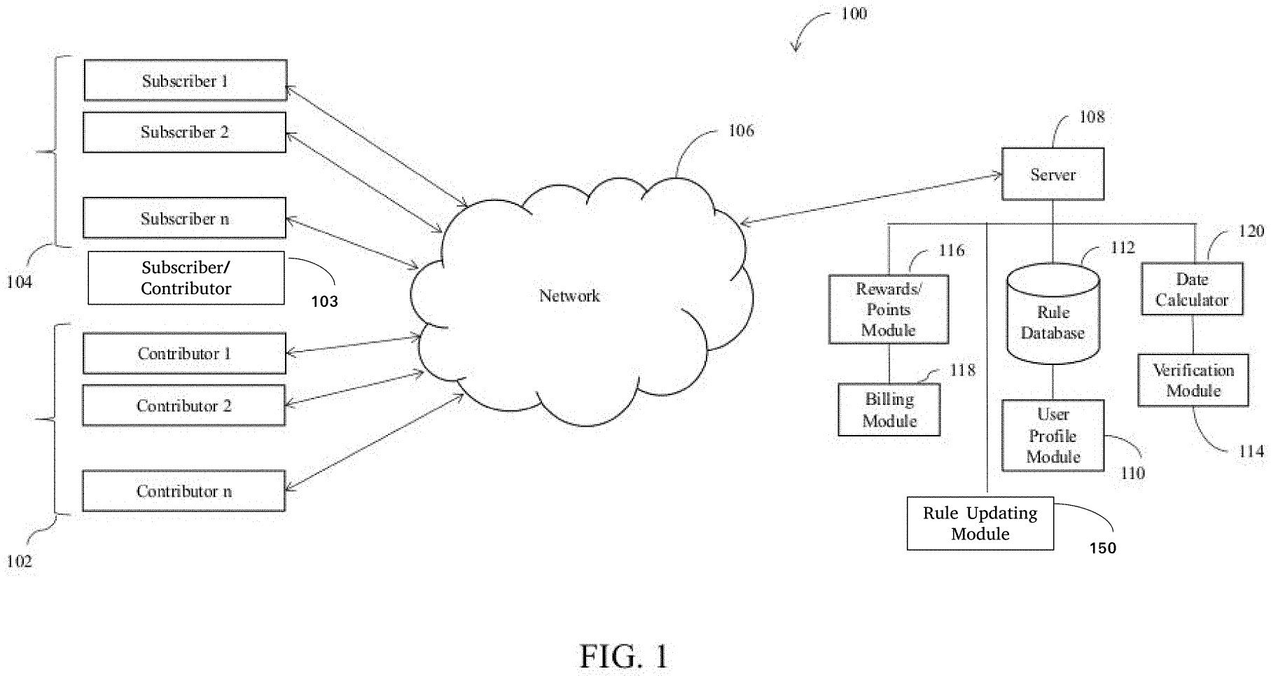

FIG. 1 shows a system 100 for providing users with updated rules, procedures, deadlines, and “best practices” that need to be conformed to for their particular profession and/or industry using a community exchange framework. Community contributors enter and verify the rules, removing a large percentage of overhead needed by contemporary rule updating services, which may translate into lower subscription rates for all users of the rule updating service as well as a greater understanding of the deadline rules and best practices that otherwise pose hurdles for the novice professional and/or lay person in the particular industry.

“Users” may include both subscribers, who subscribed to the rule updating and date calculation service, and contributors, who enter the new rules, and who may also be “subscribers” that use the system to calculate dates through a paid subscription and/or a point/reward system, and as such a user may be described as a Subscriber/Contributor 103, as described below.

Contributors 102 and Subscribers 104 may use a variety of type of networked user input devices, e.g., personal computers, notebook computers, tablets and/or smart phones to register with the system, and input and receive information over one or more networks 106, e.g., the Cloud, through a server 108. Registration may include, for example, name, billing information and selected service package, profession, professional license, professional association admission information, notification preferences, etc. This information may be stored in a user profile module 110.

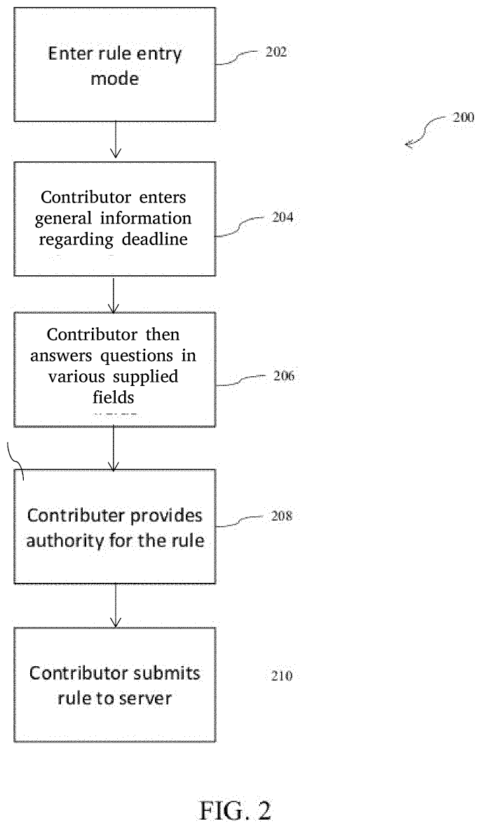

FIG. 2 shows a flowchart describing an operation 200 for a contributor to enter a deadline rule triggering event, such as the receipt of a particular document, or one or more new rules for a rule triggering event whether existing or just added. The contributor would enter a “rule triggering event” adding mode or a rule entry mode 202 of an application provided by the server.

The contributor enters general information in various supplied fields 204, such as the name of the document or other rule-triggering event, a title and description of the deadline, and the largest jurisdiction that the contributor is confident across which this rule applies, which may be selected by, e.g., a series of pull-down menus and text and numeric entry boxes.

The contributor also answers questions directed to the specifics of the deadline in various supplied fields 206, such as, for example, is the deadline rule triggered by receipt of a document, the notice of a date, or the date of a hearing or trial?

Other exemplary questions include the following: Does this deadline occur before or after the triggering document or event? How many days before or after the triggering event does this deadline occur? Are these days counted as sequential Calendar Days or as Court Days? Do we add a number of days to this deadline rule based on how a document is delivered? Do we add days to the time for this deadline rule based on where the document is delivered from or sent to?

The contributor is then asked to copy and paste a link to the authority for this rule 208.

The contributor may also be asked to enter any “Best Practices” advice related to this rule, or any other notes or comments related to this rule.

The contributor is then prompted to “Submit the Rule” 210.

In an embodiment, where a user searches for a rule triggering event such as a particular document, that they may have just received, and can't find it, the system may provide a “Triggering Event Entry Mode” where the user may enter the rule triggering event, such as the document.

After the user enters the rule triggering event, the user may enter one or more rules that are associated with that event, such as the receipt of a Motion for Demurrer which might have multiple associated deadline rules.

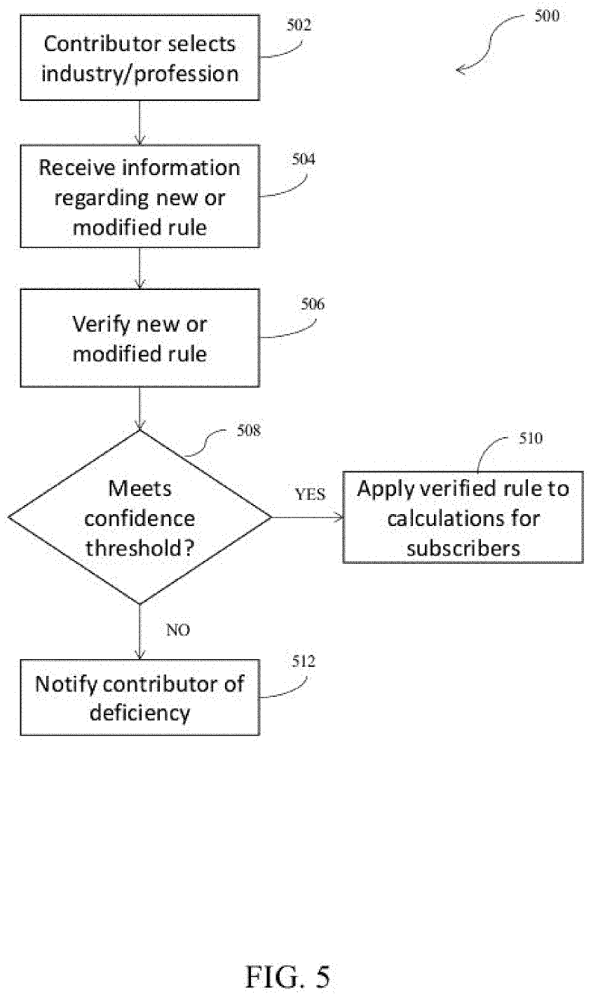

Also, where a user has found the triggering event already exists in the system for their particular jurisdiction of interest, but they either don't see an associated rule for that triggering event, or they see a rule that appears incorrect, the system may allow them to go to an “Add-A-Rule” mode for an existing rule triggering event, e.g, a document, or click on a rule they might want to update or modify, as discussed in reference to FIG. 5. This “Modify-A-Rule” mode may be effectively the same as “Add-A-Rule” Mode, but the system may present the existing rule and fill in the fields and allow the user to modify one or more of the fields.

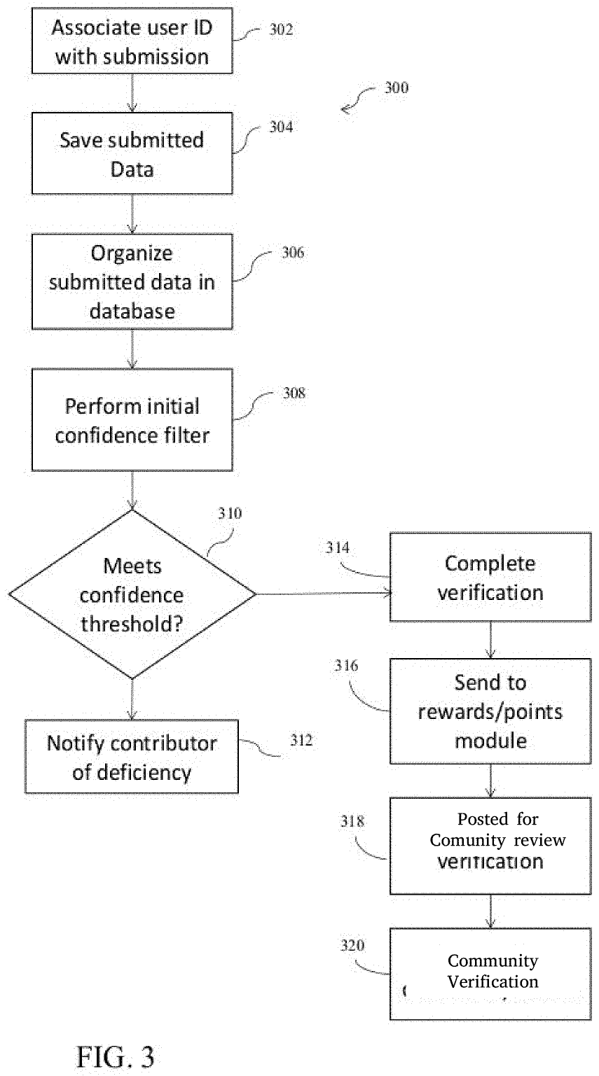

FIG. 3. shows a flowchart showing a rule submission operation 300 from the server side according to an embodiment. All of the data included in the contributor-submitted rule may be associated with an identification assigned to the contributor 302. The submitted data is saved 304 in a rule database 112, including the jurisdiction, name of the document, title of deadline, etc. The database may organize the data hierarchically, by using linked tabs, or any of a number of database data storage and processing techniques 306.

A verification module 114 may perform an initial confidence filter 308 based on the credibility of the contributor, e.g., from veracity of prior submissions or other factors as noted by other community contributors, whether the text entered with the URL in the rule submission corresponds substantially with text from the source URL, and the type and confidence of the URL source material (e.g., .gov, .com, .edu, etc.), etc. The verification module 114 may give a “confidence rating” for the contributors and for each rule, as a rule may have multiple contributors and thus a “rule confidence rating” that is formed from the sum of the ratings of the contributors.

For example, the confidence filter may be expressed as an equation in an embodiment:

f(contributor confidence, text matching, URL, source confidence).

These and/or other factors could be weighted based on overall relevance and efficacy. The confidence measures for the various factors may be determined by, e.g., statistical analysis, stochastic operations, machine learning, big data, etc.

If the confidence factor is determined to be sufficient (e.g., above a certain threshold) 310.

The new rule information may be posted for community review 318. If not, the submissions may be ignored, and/or the contributor notified of the deficiencies 312. Once posted, other users may verify, modify, correct, or question the submitted rule, i.e, community verification 320.

In an embodiment, the user (as a contributor) entering, editing, or validating the rule may be given a weight. Contributors may be assigned a Contributor Trust Score, which may factor in calculating the rule confidence score. For example, attorneys with the most experience in the applicable area of law might have the highest trusted contributor score, then, regressing from there based on experience, any attorney, but again with the contributor trust score adjusted based on their number of years of experience, then paralegals along with their number of years in practice, followed by legal assistants and then lay people.

The trusted contributor score could be further adjusted based on the number of positive validations of any rule they entered, versus the number of times rules they entered had to be corrected (a negative factor to a contributing user's trust score). All of the above factoring may be normalized such that a rule that falls under a certain level of confidence may not be displayed for use whereas a rule that garners a level of confidence above that threshold level will be displayed but will also be displayed with its confidence score. Thus, displayed rules might show confidence scores of, say, 80% to 100%. Alternatively, other levels of confidence may be displayed, e.g., a number of stars, certain colors, or other visual indicators to indicate the level of confidence a user can place in a displayed rule.

The original contributor and those who provide feedback on the submitted rule may receive rewards, e.g., in the form of points, for their relative contribution. A rewards/points module 116 may calculate points, e.g., 1,000 points for adding the rule, 500 for being the first to correct the rule, 250 for being the second, etc., and 250 for being the first the verify the rule, 100 for being the second, and 30 for later users. This is just an exemplary points scheme. The rewards/points module may send these points along with the contributor identification 110 to a billing module 118.

The points may then be used by the contributor in exchange for free use of the system for a certain period, or for system account credit, or for cash payment. The service may allow a user to use certain limited capabilities of the system, whether or not they have contributed. If they do contribute, they can use Reward Points to allow them to use more premium features of the system such as automatic notifications, exporting of deadlines to their calendaring system (e.g., Google Calendar, Outlook, etc.), storage of case history, etc.

Once the verification process is complete 314, the submitted rule may be flagged as verified, and used in date calculations.

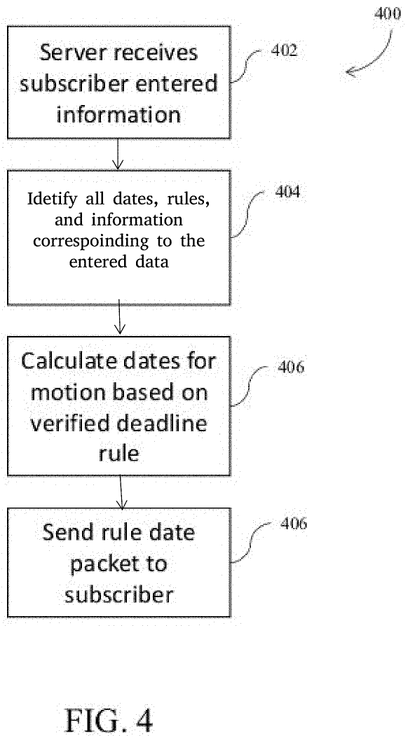

FIG. 4 shows a flowchart showing a date calculation operation 400 at the server. In this example, a deadline has been changed and verified by the system, e.g., “opposition to a motion must be filed with the court 10 court days before the motion hearing date” has been changed to “9 court days”.

The subscriber enters information and initial dates for a motion. The user may enter the document type (e.g., Anti-SLAAP motion), jurisdiction (California), delivery method (overnight mail), proof of service date (Jun. 23, 2020), and hearing date (Jul. 18, 2020). When the server receives the entered data 402, the rule database identities all dates, rules, and information with associated deadline dates corresponding to the entered data 404, and based on the relevant rule with the highest confidence score, a date calculator module calculates important dates for the motion 406. A rule date packet may then be sent back to the subscriber in an organized format 408. In this example, based on the entered information, the rule date packet may indicate the following:

Friday, Jun. 12, 2020

Reserve Hearing Date with the Court Calendaring Clerk (only if you're filing the motion) at least 23 days before you want the motion to be heard

Tuesday, Jun. 23, 2020

Last date to file and serve the motion

Thursday, Jun. 25, 2020

Last date to conduct a Meet and Confer regarding the motion (must be done by phone or in person)

Tuesday, Jul. 7, 2020

An Opposition to a motion must be filed with the court 9 court days before the motion hearing date.

Wednesday, Jul. 8, 2020

An Opposition to any motion (other than a Motion for Summary Judgment) must be received by all opposing attorneys or parties (if unrepresented by an attorney) no later than one business day after it was filed with the court.

Monday, Jul. 13, 2020

A Reply to a motion must be filed with the court 5 court days before the hearing

Saturday, Jul. 18, 2020

Hearing date for the motion.

In alternative embodiments, the system 100 is not limited to court rules. Any industry or profession that has deadline rules and “best practices” rules may be similarly serviced. For example, in construction, a best practice to put up framing at earliest four weeks after concrete is poured may be changed based on many factors, including improvement in materials or a change in local ordinances. In medicine, for example, with regard to treatment and monitoring of coronavirus or Covid 19 there may be changes originating from the Center for Disease Control (CDC) regarding times for testing and re-testing, as well as available new or recommended medications and/or treatments, and changes in recommended self-quarantine times. Other exemplary industries and professions include tax consultants, telecommunications, banking, law enforcement, etc.

In an embodiment, a user (contributor/subscriber) may “Select Industry” in the provided application, and then, if necessary, modify the “add or verify a deadline rule” questionnaire as needed for the selected industry or profession.

FIG. 5 shows a flowchart for a general operation 500 for updating rules, deadlines, and procedures in a community exchange system. A contributor selects an industry or profession 502. The server receives information from the contributor regarding a new triggering event or a new or modified “rule,” for a particular (existing or added) triggering event, including deadlines, procedures, best practices, etc., 504. The server verifies the new or modified rule using automated and/or community provided information and generates a Rule Confidence Score 506. If the rule confidence score exceeds a confidence threshold 508, the new or modified rule is considered verified sufficiently to be displayed to the community of users 510. If so, the verified rule is applied to calculations for subscribers 510. If not the submitted rule is discarded and/or the contributor notified of its deficiency 512. The remaining operation follows the general flow of FIG. 4.

In an embodiment, the system may include a Rule Updating Module 150, as shown in FIG. 1, where the exact text of all legislative rules that have been entered into system. By periodically comparing that stored text against the text of the rule on the legislative website, the system can generate a list of laws where any of the text has changed, identify the section of changed text, and add a task for any interested contributors to review the changed text and see how it might modify the deadline rule in our system.

The Rule Updating Module 150 would also send this task to a contributor and give them a certain amount of time to update the rule or otherwise indicate no update is necessary, and if neither of those things are done within that timeframe, then the task would be sent to another contributor, etc., until the rule had been corrected or labeled “no impact on existing rule”.

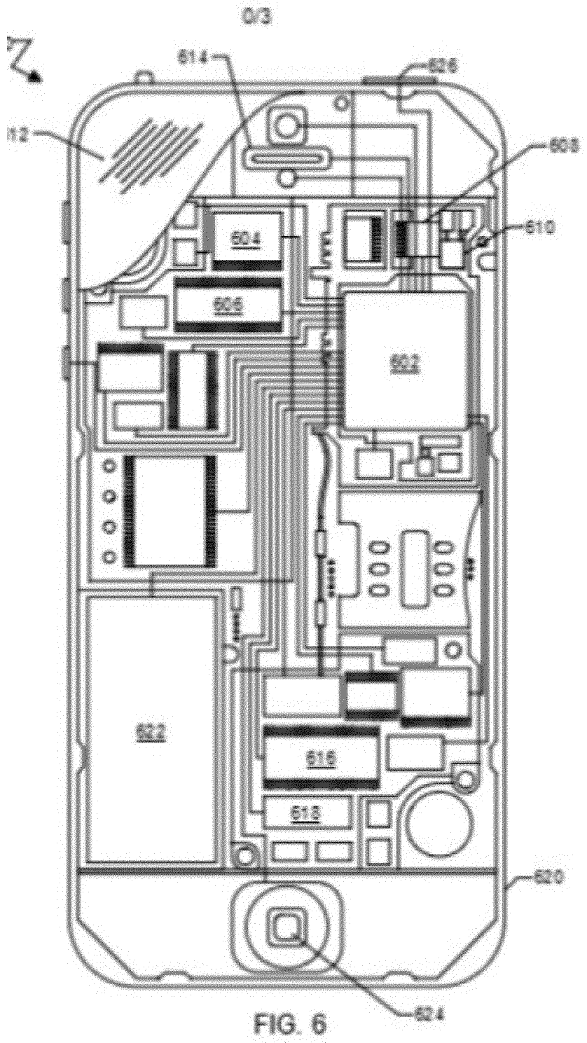

FIG. 6 is a block diagram illustrating an example wireless communication device suitable for use with the various aspects described above. The mobile computing device 600 may include a processor 602 coupled to a touchscreen controller 604 and an internal memory 606. The processor 602 may be one or more multicore integrated circuits designated for general or specific processing tasks. The internal memory 606 may be volatile or non-volatile memory and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the computing device 600 need not have touch screen capability.

The mobile computing device 600 may have one or more radio signal transceivers 608 (e.g., wifi, LTE, etc.) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile computing device 600 may include a wireless modem device 616 thus enabling communication via a wireless network.

The mobile computing device 600 may include a peripheral device connection interface 618 coupled to the processor 602. The peripheral device connection interface 618 may be singularly configured to accept one type of connection, or may be configured to accept various types of physical and communication connections, common or proprietary, such as Universal Serial Bus (“USB”), FireWire, Thunderbolt, PCIe, Lightning, etc. The peripheral device connection interface 618 may also be coupled to a similarly configured peripheral device connection port (not shown). In one aspect, the peripheral device connection interface 618 may utilize wireless technology (e.g., Bluetooth) to communicate with devices.

The mobile computing device 600 may also include a speaker 614 for providing audio outputs. The mobile computing device 600 may also include a housing 620, constructed of a plastic, metal, or a combination of materials, for containing all or some of the components described herein. The mobile computing device 600 may include a power source 622 coupled to the processor 602, such as a disposable or rechargeable battery. The rechargeable battery may also be coupled to the peripheral device connection interface 618 to receive a charging current from a source external to the mobile computing device 600. In one aspect, the mobile computing device 600 may receive charging current via a wireless interface (e.g., Qi). The mobile computing device 600 may also include a physical button 624 for receiving user inputs. The mobile computing device 600 may also include a power button 626 for turning the mobile computing device 600 on and off.

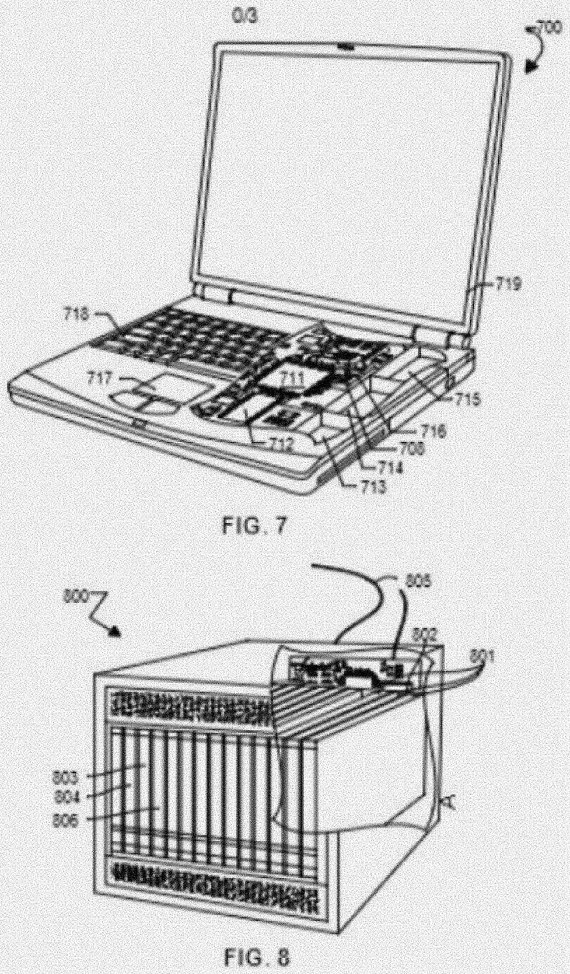

FIG. 7 is a block diagram illustrating an example computing device suitable for use with the various aspects described herein. A computing device 700 is depicted. The computing device 700 may include a processor 711 (e.g., an ARM processor) coupled to volatile memory 712 (e.g., DRAM) and a large capacity nonvolatile memory 713 (e.g., a flash device). Additionally, the computing device 700 may have one or more antenna 708 for sending and receiving electromagnetic radiation that may be connected to a wireless data link and/or cellular telephone transceiver 716 coupled to the processor 711. The computing device 700 may also include an optical drive 714 and/or a removable disk drive 715 (e.g., removable flash memory) coupled to the processor 711. The computing device 700 may include a touchpad touch surface 717 that serves as the computing device's 700 pointing device, and thus may receive drag, scroll, flick etc. gestures similar to those implemented on computing devices equipped with a touch screen display as described above. In one aspect, the touch surface 717 may be integrated into one of the computing device's 700 components (e.g., the display). In one aspect, the computing device 700 may include a keyboard 718 which is operable to accept user input via one or more keys within the keyboard 718. In one configuration, the computing device's 700 housing includes the touchpad 717, the keyboard 718, and the display 719 all coupled to the processor 711. Other configurations of the computing device 700 may include a computer mouse coupled to the processor (e.g., via a USB input) as are well known, which may also be used in conjunction with the various aspects described herein.

FIG. 8 is a block diagram illustrating an example server suitable for use with the various aspects described herein. Such a server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by inserting them into the racks of the assembly. The server 800 may also include an optical drive 806 coupled to the processor 801. The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.)

The system described provides multiple technological and efficiency aspects over existing solutions. As a community exchange system, the contributors, most typically licensed industry practitioners, are more qualified than the employees charged with handling the changes in the rules, as the employees are not always licensed professionals. They may not understand the bases of the rules as well as might our contributor, who has more experience in the day-to-day application of the rules and best practices and who has had to actually deal with this and perhaps other such rule modifications in a competitive and rapidly-changing environment—that is, the employees who monitor changes in rules do not understand the day-to-day importance and impact of a few changes in the rules and are less qualified to add best practices to the system.

Experienced and concerned practitioners are more qualified to identify changes in rules, and as such, the present system provides a more accurate and more rapid method of implementing rule changes, as, in general, one or more practitioners will act on a change in the rules more rapidly than a non-professional in a “rule mill,” and will do so based on more reliable information.

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash memory, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

What is claimed is:

1. A method, the method comprising:
receiving from a first user data identifying a rule-triggering event along with one or more rule deadlines and/or best practices associated with that triggering event;
storing the new rule triggering event data;
storing the new rule deadline data;
storing the associated best practices data;
posting the triggering event, new rule deadline, and new best practices data for review by other users;
receiving feedback regarding the triggering event, new rule deadline, and new best practices data from one or more of the other users; and
verifying whether the triggering event, new rule deadline, and new best practices data is accurate or not.

2. The method of claim 1, further comprising organizing the triggering event, new rule deadline, and new best practices data in a database according to general information and specific information.

3. The method of claim 1, further comprising performing a credibility filter on the triggering event, new rule deadline, and new best practices data using a computer analysis operation.

4. The method of claim 1, further comprising generating rewards for the first user and users that participated in the verification of the triggering event, new rule deadline, and new best practices data.

5. The method of claim 1, wherein, if the triggering event, new rule deadline, and new best practices data is determined to be accurate, calculating a deadline in response to a user request.

6. The method of claim 1, wherein the triggering event, new rule deadline, and new best practices comprise a law-related deadline.

7. The method of claim 6, wherein the first user and at least one of the other users that provided feedback are legal professionals.

8. A computer-readable medium storing instructions that, when executed by a computer, cause the computer to:
receive from a first user data identifying a rule-triggering event, new rule or best practices deadline;
store the triggering event and its associated new rule or best practices deadline data;
post the new rule and best practices deadline data for review by other users;
receive feedback regarding the new rule and best practices deadline data from one or more of the other users; and
verify that the new rule and best practices deadline data is accurate or not.

9. The computer-readable medium of claim 8 storing instructions that, when executed by a computer, cause the computer to organize the new rule and best practices deadline data in a database according to general information and specific information.

10. The computer-readable medium of claim 8 storing instructions that, when executed by a computer, cause the computer to generate a credibility score on the new rule and best practices deadline data using a computer analysis operation.

11. The computer-readable medium of claim 8 storing instructions that, when executed by a computer, cause the computer to generate points rewards for the first user and users that participated in the verification of the new rule or best practices deadline data.

12. The computer-readable medium of claim 8 storing instructions that, when executed by a computer, cause the computer to, if the new rule and best practices deadline data is determined to be accurate, calculate a deadline in response to a user request.

13. The computer-readable medium of claim 8, wherein the new rule and best practices deadline comprises a law-related deadline.

14. The computer-readable medium of claim 13, wherein the first user and at least one of the other users that provided feedback are legal professionals.

15. A system comprising:
a server operative to receive data regarding a new rule and/or best practices deadline data from a first user, post the new rule and/or best practices deadline data for review by other users, and review feedback from the other users;
a database operative to store and organize triggering events and their associated new rules and best practices deadline data;
a verification module to verify the new rule and best practices deadline data based on feedback from the other users and identify whether the new rule and best practices deadline data is accurate, and if so, identifying the new rule and/or best practices deadline data as verified;
a data calculation module operative to calculate a deadline based on a verified new rule and/or best practices data deadline in response to a user request.

16. The system of claim 15, wherein the verification module is operative to generate a credibility score based on the new rule and/or best practices deadline data.

17. The system of claim 15, further comprising a rewards module to assign rewards to the first user and to the users that participated in the verification.

18. The system of claim 17, further comprising a billing module operative to convert the rewards into credit for using the system to calculate deadlines.
